(19) United States
(12) Patent Application Publication
(10) Pub. No.: US 2007/0102923 A1
(43) Pub. Date: May 10, 2007

(54) Coupling system

(76) Inventor: Tapani Niemela, Mariefred (SE)

Correspondence Address: SCHIFF HARDIN, LLP;PATENT DEPARTMENT, 6600 SEARS TOWER, CHICAGO, IL, 60606-6473, US

(21) Appl. No.: 10/580,380

(22) PCT Filed: Dec. 9, 2004
(86) PCT No.: PCT/SE04/01831

§ 371 Date: May 22, 2006

(30) Foreign Application Priority Data
Dec. 10, 2003 (SE) 0303359-4

(51) Int. Cl. F16L 17/00

(52) U.S. Cl. 285/95

(57) ABSTRACT

A coupling system for transferring anaesthetic liquid from a bottle to a vaporizer as a bottle part that includes a first valve with a first spring-loaded valve body and a first reactive body, and a vaporizer part that includes a second valve with a second spring-loaded valve body and a second reactive body. A seal is disposed between the first valve body and the first reactive body of the bottle part, and a further seal is disposed between the second valve body and the second reactive body of the vaporizer part. The seals are positioned and the reactive bodies are arranged so that, when the bottle part and the vaporizer part are coupled together, the seal of the bottle part abuts sealingly against the second reactive body, and the seal of the vaporizer part abuts sealingly against the first reactive body.

### BACKGROUND OF THE INVENTION

1. Field of the Invention

The present invention relates to a coupling system for transfer of an anaesthetic fluid from a bottle to a vaporizer.

2. Description of the Prior Art

A coupling system for transferring anaesthetic fluid from a bottle to a vaporizer is known that has a bottle part having a first valve with a first spring-loaded valve body and a first reactive body, and a vaporizer part having a second valve with a second spring-loaded valve body and a second reactive body. The bottle part and the vaporizer part are adapted to be coupled together, with the first reactive body being arranged so as to act on the second spring-loaded valve body in an opening direction, and the second reactive body being arranged so as to act on the first spring-loaded valve body in an opening direction so as to form a flow-path for the anaesthetic fluid. A seal is arranged between the first valve body and the first reactive body of the bottle part, and a further seal is arranged between the second valve body and the second reactive body of the vaporizer part.

During inhalation anaesthesia, a mixture containing anaesthesia is given to a patient via the respiratory passages. The anaesthesia is usually provided in liquid form in a vaporizer, and a certain amount of fluid is vaporized in accordance with the needs for supply to the patient. The vaporizer contains a limited amount of liquid, and refilling of the liquid may be necessary during a progressive narcosis.

When filling liquid to the vaporizer it is important to make sure that the anaesthesia does not reach the surroundings and is vaporized. Above all, there are two reasons for this. A short-term effect is that the nursing staff is negatively affected during surgery by anaesthetic gas. A long-term effect is that staff exposed during extended periods of time to anaesthetic gases can develop cancer.

A common disadvantage of known coupling systems is that liquid remains in the coupling when the parts are pulled apart after being coupled together, thereby allowing the liquid to evaporate into the surroundings.

In conjunction with a coupling system of the type initially mentioned, and which is described in EP 1 304 132 A1, attempts have been made to solve said problem by arranging the two parts of the coupling system so that the spring-loaded valve body and the reactive body in the respective part substantially form a plane surface. Due to the plane surfaces of the parts, there is in principle no volume between the parts that could be filled with liquid. However, liquid seeping in between the surfaces and forming a liquid film cannot be completely avoided. Since the plane surfaces of the coupling system are relatively large, a considerate amount of fluid can vaporize into the surroundings when the parts are pulled apart.

### SUMMARY OF THE INVENTION

An object of the invention is to present a coupling system of the type initially described that insures that no or a negligible spill of liquid will occur when the bottle is removed from the vaporizer.

This problem is solved in a coupling system of the type initially described wherein that the seals are positioned and the reactive bodies are arranged so that, when the bottle part and the vaporizer part are coupled together, the seal of the bottle part abuts sealingly against the second reactive body, and the seal of the vaporizer part abuts sealingly against the first reactive body. The positioning of the seals makes it impossible for fluid to leak during filling and form a film between the parts. After separation of the parts, only a negligible part of the coupling, which during filling was in contact with the fluid, will now come in contact with the surrounding air.

In an embodiment of the coupling system according to the invention, the distance between the respective seal and reactive body is such that, upon coupling together of the bottle part and the vaporizer part, the seal of the vaporizer part firstly comes into contact with the first reactive body. Thereby, a tight connection is secured between the vaporizer part and the bottle part before the valve body of the bottle part and the reactive body of the vaporizer part are displaced to a position in which the flow-path for the anaesthetic fluid is open.

In preferred embodiment of the coupling system according to the invention the first valve body has a recess. A recess makes it more difficult to open the valve body of the bottle part by mistake.

According to a further preferred embodiment of the coupling system according to the invention it is suggested that the second reactive body has a protruding part, the shape of which corresponds to the recess. Thereby, it is difficult to open the spring-loaded valve body of the vaporizer part by mistake.

### DESCRIPTION OF THE DRAWINGS

FIG. 1 is a side sectional view of a coupling system in accordance with the present invention, with a bottle part and a vaporizer part separated from and facing each other.

FIG. 2 shows the coupling system of FIG. 1 in a partially coupled, but still closed, position.

FIG. 3 shows the coupling system according to FIGS. 1 and 2, in a position wherein the inlet of the vaporizer part is partly opened but the outlet of the bottled part is closed.

FIG. 4 shows the coupling system of FIGS. 1, 2 and 3 in an open position allowing gas flow therethrough.

### DESCRIPTION OF THE PREFERRED EMBODIMENTS

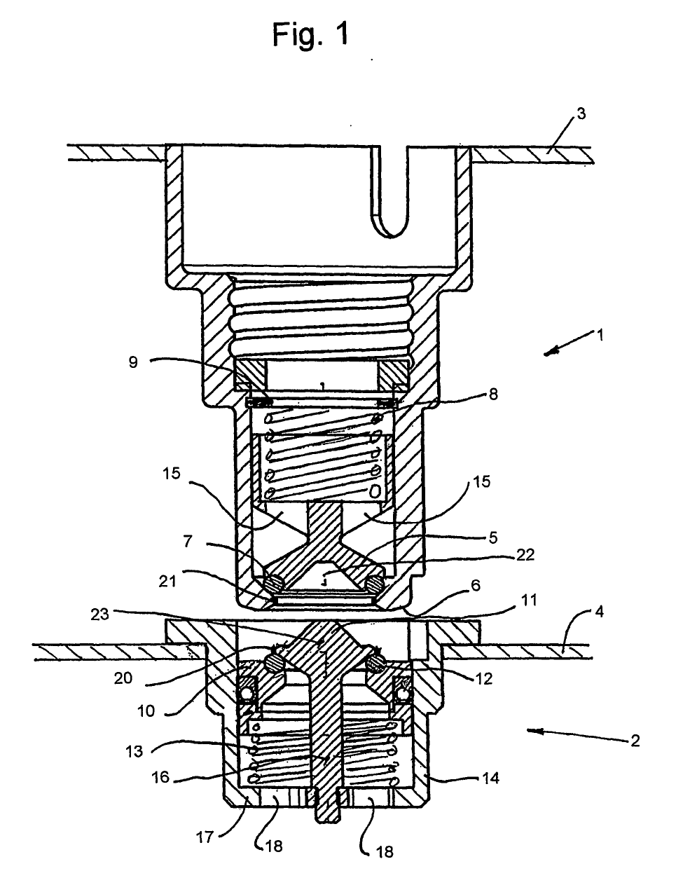

In FIG. 1, a coupling system is shown in a side view with a bottle part 1 and a vaporizer part 2 shown in longitudinal cross-section, which parts are shown facing each other. The bottle part 1 is fitted to or is a part of a bottle 3, and the vaporizer part is mounted in a vaporizer 4 of a narcosis apparatus.

The bottle part 1 has a first valve formed by a spring-loaded valve body 5 and a reactive body 6. The reactive body 6 is formed by the free end side of the bottle part 1. Between the valve body 5 and the reactive body 6 a seal 7 is provided in the form of an O-ring seal that is fastened to the valve body 5. The spring 8 for the valve body 5, pushing the seal 7 against the inner side of the reactive body 6, is, as shown in the Figure, tightened between a lock ring 9 and the side of the valve body 5 that is directed towards the lock ring 9. The valve body 5 is also provided with channels 15.

The vaporizer part 2 has a second valve with a spring-loaded valve body 10 and a reactive body 11, which bodies 10, 11 are placed in a housing 14. Between the valve body 10 and the reactive body 11 a seal 12 is provided in the form of a O-ring seal, which is fastened to the valve body 10. The spring 13 for the valve body 10, which pushes the seal 12 against the lower side of the reactive body 11, is tightened between the inner side of the housing 14 of the vaporizer part 2 and the side of the valve body 10 that is facing said inner side. The reactive body 11 forms a part of a shaft 16, which is fixed to the bottom 17 of the housing 14. The bottom 17 is provided with channels 18.

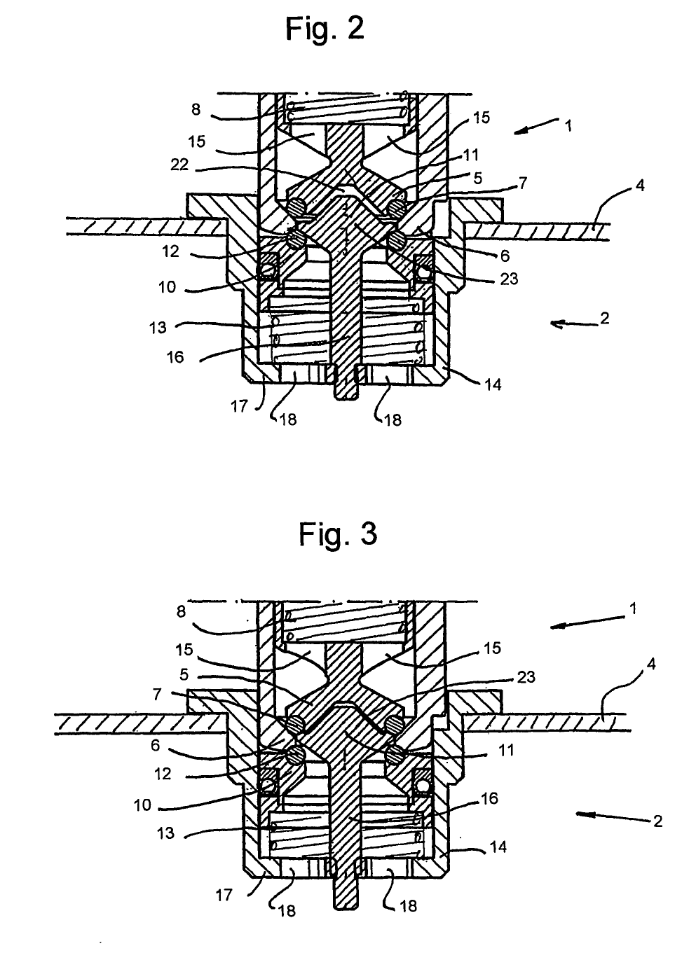

FIG. 2 shows that, upon coupling together of the parts 1 and 2, i.e. when the bottle part 1 is brought into the vaporizer part 2, the seal 12 of the vaporizer part 2 will at first come into contact with the reactive body 6 of the bottle part 1 and form a seal between the bottle part 1 and the vaporizer part 2 before any of the valves 5, 6, and 10, 11, respectively, of the parts have been opened.

FIG. 3 shows that, upon a further displacement of the bottle part 1 downwardly in the vaporizer part 2, the reactive body 6 of the bottle part 1 is pressed towards the seal 12 so that the valve body 10 of the vaporizer part 2 is pressed downwards, whereby the seal 12 leaves the lower side of the reactive body 11 of the vaporizer part 2, causing the inlet to the vaporizer part 2 and thus to the vaporizer 4 to be opened. The seal 7 of the bottle part 1 still abuts against the inner side of the reactive body 6 of the bottle part 1.

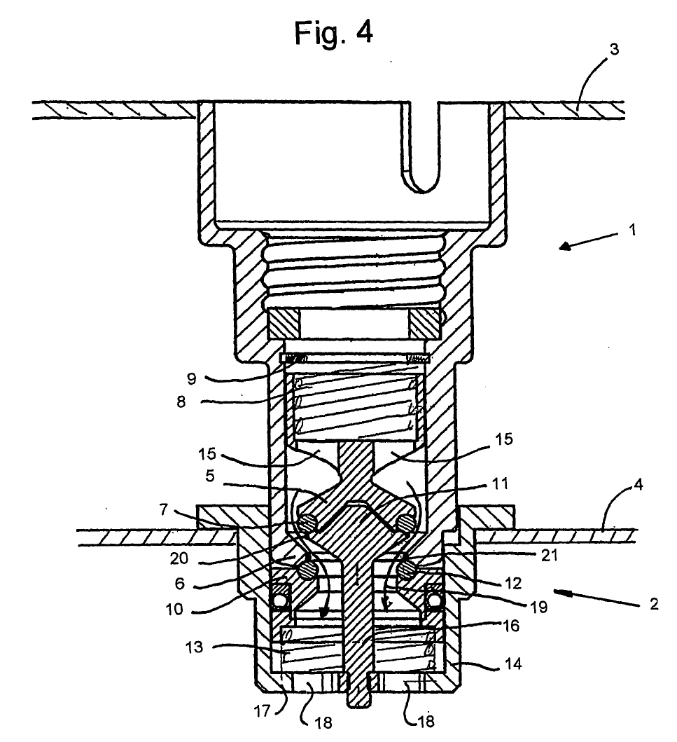

When the bottle part 1 is further pushed downwardly towards the vaporizer part 2, the reactive body 6 of the bottle part 1 pushes the seal 12 and thereby the valve body 10 of the vaporizer part 2 downwards, whereby the inlet to the vaporizer part 2 and thereby to the vaporizer 4 is completely opened. At the same time the valve body 5 of the bottle part 1 is pushed upwards by means of the reactive body 11 of the vaporizer part 2 so that the seal 7 lifts from the inner side of the reactive body 6 of the bottle part 1, whereby a flow-path for the anaesthetic fluid through the coupling system is formed, which is shown in FIG. 4. Now fluid can flow from the bottle 3 through the channels 15 in the valve body 5 and through the opening formed around the valve body 5 of the bottle part 1 and the reactive body 11 of the vaporizer part 2, which opening is indicated by arrows 19, and further into the vaporizer 4 (FIG. 1) through the channels 18.

FIG. 4 shows the parts of the coupling system that, upon filling of anaesthetic fluid, will come into contact with the fluid and that, after a separation of the bottle part and the vaporizer part, will come into contact with the surroundings. These parts are the surface of the peripheral part 20 of the reactive body 11 of the vaporizer part 2, and the surface of the inner ring of the reactive body 6 of the bottle part, which in FIG. 4 is indicated by the reference numeral 21. The peripheral part 20 and the inner ring 21 are also indicated in FIG. 1. The fluid that possibly can stick to these small surfaces is negligible.

When the bottle part 1, after completed filling of anaesthetic fluid to the vaporizer 4, is pulled upwards out of the vaporizer part, a closing of the valves 5, 6 and 10, 11 with their seals 7, 12 takes place so that the bottle part 1 as well as the vaporizer part 2 are sealed before the bottle part 1 and the vaporizer part 2 have been pulled apart. The closing of the parts 1 and 2 takes place in an inverted order as compared to what has been described above in connection with FIGS. 1-4.

In FIGS. 1-4, it is shown that the valve body 5 of the bottle part 1, as described above, can have a recess 22. Also the reactive body 11 of the vaporizer part 2 can have a protruding part 23, the shape of which corresponds to fit into recess 22. The advantages of this are presented above in the introduction of the description. The coupling system according to the invention works in the same way as described, even if the valve body 5 and the reactive body 11 are replaced by a planar arrangement.

Although modifications and changes may be suggested by those skilled in the art, it is the invention of the inventor to embody within the patent warranted heron all changes and modifications as reasonably and properly come within the scope of the inventor's contribution to the art.

I claim as my invention:

1. A coupling system for transfer of an anaesthetic liquid from a bottle to a vaporizer, comprising a bottle part comprising a first valve with a first spring-loaded valve body and a first reactive body, and a vaporizer part comprising a second valve with a second spring-loaded valve body and a second reactive body, the bottle part and the vaporizer part being connectable to each other, with the first reactive body arranged to act on the second spring-loaded valve body in an opening direction, and the second reactive body arranged to act on the first spring-loaded valve body in an opening direction, to provide a flow-path for the anaesthetic liquid, a seal disposed between the first valve body and the first reactive body of the bottle part, and a further seal disposed between the second valve body and the second reactive body of the vaporizer part, the seal and the further seal being positioned, and the first and second reactive bodies being arranged to cause, when the bottle part and the vaporizer part are coupled together, the seal of the bottle part to abut sealingly against the second reactive body, and the further seal of the vaporizer part to abut sealingly against the first reactive body.

2. A coupling system according to claim 1, the distance between the seal and the further seal and the respective first and second reactive bodies have a distance therebetween that causes, when the bottle part and the vaporizer part are coupled together, the seal of the vaporizer part to first come into contact with the first reactive body.

3. A coupling system according to claim 1 wherein the first valve body has a recess therein.

4. A coupling system according to claim 2, wherein the second reactive body has a protruding part, having a shape conforming to the recess.

5. A method for hermetically coupling and decoupling a bottle part and a vaporizer part, wherein the bottle part comprises a first outer reactive body, a first spring-loaded valve and a first inner seal between the a first spring-loaded valve and the first outer reactive body, and wherein the vaporizer part comprises a second outer reactive body, a second valve body, and a second inner seal between the a second valve body and the second outer reactive body comprising the steps of:
coupling the bottle part and the vaporizer part hermetically together by effecting contact between the first inner seal and the second outer reactive body, and by effecting contact between the second inner seal and the first outer reactive body; and
decoupling the bottle part from the vaporizer part, in the bottle part, the first spring-loaded valve forming a hermetic seal with the first inner seal and, in the vaporizer part, the second valve body forming a hermetic seal with the second inner seal prior to separation of the parts to trap any gasses remaining in the bottle part and the vaporizer part in their respective parts so that virtually no gas escapes after the parts are separated.

6. A method according to claim 5 comprising decoupling the bottle part from the vaporizer part by pulling apart the bottle part from the vaporizer part with sufficient force to separate the parts.

7. A method according to claim 5 wherein the second reactive body has a protruding part thereon and the first reactive body has a recess conforming to said protruding part, and comprising coupling the bottle part and the vaporizer part by pushing together the bottle part and the vaporizer part and thus causing the outer protruding part to mate with the recess and open the first spring-loaded valve and the second reactive body to allow gas to freely flow between the bottle part and the vaporizer part.
